(19) United States
(12) Patent Application Publication
(10) Pub. No.: US 2026/0358802 A1
(43) Pub. Date: Nov. 12, 2026

(54) Intelligent Network for Beyond Line of Sight Operation of Unmanned Aerial Vehicles

(71) Applicant: Northeastern University, Boston, MA (US)

(72) Inventors: Salvatore D'ORO, Brookline, MA (US); Tommaso MELODIA, Newton, MA (US); Michele POLESE, Cambridge, MA (US); Leonardo BONATI, Boston, MA (US); Matteo BORDIN, Boston, MA (US); Pietro BRACH DEL PREVER, Somerville, MA (US)

(21) Appl. No.: 19/113,568

(22) PCT Filed: Nov. 28, 2023
(86) PCT No.: PCT/US2023/081335

§ 371 Date: Mar. 20, 2025

Related U.S. Application Data
(60) Provisional application No. 63/428,399, filed on Nov. 28, 2022.

(51) Int. Cl. G05D 1/226; B64U 20/80; G08G 5/26; G08G 5/57; G08G 5/72; H04L 41/16; H04W 4/021; H04W 4/024; H04W 4/44; H04W 4/50; H04W 24/02; H04W 36/00; H04W 36/08; H04W 84/06

(52) U.S. Cl. CPC G05D 1/226; B64U 20/80; G08G 5/26; G08G 5/57; G08G 5/727; H04L 41/16; H04W 4/021; H04W 4/024; H04W 4/44; H04W 4/50; H04W 24/02; H04W 36/00837; H04W 36/08; B64U 2201/10; B64U 2201/20; H04W 84/06

(57) ABSTRACT

Provided herein are methods and systems for beyond line of sight control of autonomous vehicles including a wireless network having an Open RAN infrastructure in communication with a core network and a MEC infrastructure, a MEC orchestrator deployed in the Open RAN infrastructure and including MEC computing nodes and a ground control station, a catalog in communication with the orchestrator and including MEC function apps for operating the MEC infrastructure and/or the core network, and Open RAN apps for operating the Open RAN infrastructure, wherein the orchestrator is configured to process data from the MEC infrastructure, the core network, the open RAN infrastructure, or combinations thereof, and instantiate the MEC function apps in the MEC infrastructure and/or core network, instantiate the Open RAN apps in the Open RAN infrastructure, or combinations thereof to manage a plurality of vehicle functions and/or wireless network functions responsive to data from the vehicles.

### CROSS REFERENCE TO RELATED APPLICATIONS

This application claims benefit under 35 U.S.C. § 119(e) of U.S. Provisional Application No. 63/428,399, filed on 28 Nov. 2022, entitled “Intelligent Network for Beyond Line of Sight Operation of Unmanned Aerial Vehicles,” the entirety of which is incorporated by reference herein.

### BACKGROUND

Thanks to their size, speed, 3D mobility and the capability to bring connectivity in otherwise uncovered areas, Unmanned Aerial Vehicles (UAVs), also known as drones, have been identified as enabling technologies for a wide range of applications, including smart monitoring, asset tracking and surveillance, rescue missions, and emergency scenarios.

While the use of UAVs for line-of-sight (LOS) applications is well-regulated and well-established, their use in beyond LOS (BLOS) scenarios (e.g., in those cases where a pilot cannot maintain visual contact with the UAV) is still developing due to safety regulations and concerns. Indeed, while LOS applications can always rely upon a pilot in direct control of the UAV at all times thanks to point-to-point links between the remote controller (RC) and the UAV, BLOS introduces an intermediate networking element that is in charge of connecting a remote pilot with the UAV. Therefore, it becomes essential for this intermediate networking element to be reliable and to guarantee continuous and uninterrupted communications to and from the UAV. 5G networks and Multi-access Edge Computing (MEC) are the ideal candidates for this intermediate component as they promise ultra-low latency communications, high data rates and a distributed edge computing platform that, when combined, can effectively tackle the need for fast and high-performance communications required to support BLOS UAV applications. However, as of today, native 5G networks are still closed, inflexible and, thus, not sufficient alone to meet those requirements due to the lack of the required intelligence to make dynamic decisions. In order to solve these issues, Open RAN (O-RAN) technologies, such as those heralded by the O-RAN Alliance, will play a major role in making BLOS UAV applications a reality thanks to their openness, software-based implementation, support for native Artificial Intelligence (AI) and customizability.

The O-RAN Alliance embraces the 3GPP functional split where traditionally monolithic base stations of the Radio Access Network (RAN) are disaggregated into software-based Centralized Units (CUs), Distributed Units (DUs) and Radio Units (RUs) implementing different functions of the protocol stack. O-RAN also introduces (i) a set of open standardized interfaces to interact (E2, A1), control (E2, A1) and collect data (O1) from every node of the network; as well as (ii) RAN Intelligent Controllers (RICs) that execute third-party applications over an abstract overlay to control RAN functionalities, i.e., xApps in the near-real-time and rApps in the non-real-time RIC. The O-RAN architecture makes it possible to bring automation and intelligence to the network through AI.

Numerous techniques have been studied in attempts to overcome the BLOS communication problem for UAVs. Some systems use one UAV as a communication relay point to enable other UAVs to operate in areas where direct communication with ground control stations cannot be established. Similarly, some systems use a UAV relay in combination with directional antennas to extend UAV control distance to several kilometers with high data throughput. However, these solutions require the deployment of one or more additional UAVs, which is not always feasible and also adds significant costs with respect to time, financial resources, and computing resources. Moreover, these systems were developed for LTE and not tested or optimized for 5G. Although these two technologies have similar underlying features, 5G usually smaller coverage, which simultaneously makes BLOS more relevant and even more difficult to solve. In particular, LTE base stations have longer range and thus larger coverage areas, which makes it easier to deliver services, even in suburban deployments as compared to the shorter range and smaller coverage areas associated with 5G base stations.

Other systems propose the integration of UAVs and 5G cellular networks by splitting the Flight Control System (FCS) between the UAV and the MEC of the 5G network. From the information collected during flight, an AI-driven optimization technique is used to support real-time flight decisions, which results in efficient flight. However, due to computing and bandwidth resource limitations, such systems are not scalable for use cases wherein a swarm of drones has to fly in BLOS, particularly with 5G communication. Academic papers have proposed the use of satellites to communicate with swarms in BLOS, but satellite communications can more frequently suffer from interruptions and no study has been performed to assess he latency and reliability of such a connection. A combination of mm Wave and directional beams has also been studied to attempt to increase spectral efficiency for a swarm of drones in BLOS. However, none of these systems or proposals has provided a workable, reliable, and broadly applicable technique for meeting the low latency and high data throughput requirements associated with BLOS UAV operations. Furthermore, no such systems are able to combine O-RAN technologies, AI, network slicing, and MEC services over 5G (or other wireless network) links for BLOS UAV operations.

Open RAN (e.g., O-RAN) is a rapidly growing key technology in the field of wireless communications and much research continues to explore development and control of Open RAN systems. The inventors have previously developed various Open RAN systems in other contexts. For example, OpenRAN Gym is a unified framework for seamlessly instantiating Open RAN networks to provide 5G capabilities, perform data collection, and train and deploy AI solutions to control network functionalities in the form of xApps. OpenRAN Gym combines several frameworks, including: (i) SCOPE, which offers a portable framework based on srsRAN and OpenAirInterface to deploy and control 5G networks via only a few lines of code, intuitive APIs, and support for network slicing; (ii) ColO-RAN, an O-RAN compliant implementation of a near-real-time RIC and E2 interface that can be used in combination with SCOPE to develop and execute AI-driven xApps for 5G use cases; (iii) an orchestration framework for automating the selection and deployment of xApps; and (iv) SI-EDGE, a framework to orchestrate networking and MEC services with support for network slicing. However, no solutions exist that provide integration of ORAN with the operation of UAVs, particularly with respect to BLOS UAVs. In fact, although O-RAN for UAVs is recognized as a significant use case of acknowledged importance within the O-RAN Alliance, the integration of O-RAN with UAVs has remained an unsolved challenge.

### SUMMARY

Described herein are intelligent networks for beyond line of sight (BLOS) operation of Unmanned Aerial Vehicles (UAVs). In some embodiments, such networks include a unified wireless framework (e.g., for use on a 5G network) for BLOS operation of automated vehicles such as UAVs that integrates O-RAN, MEC, and AI. This unified framework, also referred to herein as “O-BLUE,” provides advances in several key aspects. First, O-BLUE provides a solution for the “O-RAN for UAV” use case identified by the O-RAN Alliance. Second, O-BLUE also provides a baseline for realizing many BLOS applications for 5G-based UAV communications that have not been possible so far. Furthermore, the O-BLUE includes an orchestrator which, along with packages of Apps (e.g., rApps and xApps) generated by O-BLUE, optimizes latency and resource allocation among automated vehicles (e.g., UAVs) and other user equipment (UE) connected in a same cell.

In one aspect, a system for beyond line of sight control of one or more autonomous vehicles is provided. The system includes a wireless network having open radio access network (Open RAN) infrastructure in communication with a core network, and a mobile edge computing (MEC) infrastructure, the wireless network including a MEC orchestrator deployed in the Open RAN infrastructure. The MEC infrastructure includes a plurality of MEC computing nodes. The MEC infrastructure also includes a ground control station. The system also includes at least one catalog in communication with the MEC orchestrator. The catalog includes a plurality of MEC function apps for operating the MEC infrastructure and/or the core network. The catalog also includes a plurality of Open RAN apps for operating the Open RAN infrastructure. The MEC orchestrator is configured to process, using artificial intelligence, data from one or more of the MEC infrastructure, the core network, the open RAN infrastructure, or combinations thereof. The MEC orchestrator is also configured to instantiate at least one of the MEC function apps in the MEC infrastructure and/or the core network, instantiate at least one of the Open RAN apps in the Open RAN infrastructure, or combinations thereof to manage one or more of a plurality of vehicle functions and/or wireless network functions in response to data collected from the one or more autonomous vehicles.

In some embodiments, the one or more autonomous vehicles include one or more of an autonomous car, an autonomous truck, an autonomous surface aquatic vehicle, an autonomous sub-surface aquatic vehicle, an unmanned aerial vehicle (UAV), or combinations thereof. In some embodiments, the one or more autonomous vehicles include one or more UAVs, each UAV comprising an onboard computer configured with a flight controller unit, an MEC host, and a wireless communication module, the UAVs in wireless communication with the wireless network. In some embodiments, the collected autonomous vehicle data includes one or more of, vehicle identification, computer vision, vehicle metrics, vehicle trajectory, or combinations thereof. In some embodiments, the Open RAN infrastructure is configured to execute the Open RAN apps responsive to detection of one or more vehicles operating within the wireless network in range of the Open RAN infrastructure. In some embodiments, the Open RAN apps, upon execution by the Open RAN infrastructure, are configured to control one or more of RAN slicing, handover from one base station of the wireless network to another base station, vehicle traffic steering, scheduling, resource allocation, or combinations thereof. In some embodiments, the Open RAN apps are configured to maintain an end-to-end latency between the ground control station and each of the autonomous vehicles of less than a maximum tolerable latency value. In some embodiments, the maximum tolerable latency value is determined as a function of an autonomous vehicle speed, a data signal type, or a combination thereof. In some embodiments, the Open RAN apps include one or more of an xApp, an rApp, or combinations thereof. In some embodiments, detection of the one or more autonomous vehicles is determined upon initiation by each autonomous vehicle of a packet data unit (PDU) session with a base station of the Open RAN infrastructure.

In another aspect, a method for beyond line of sight control of one or more autonomous vehicles is provided. The method includes receiving, at a base station of a wireless network having open radio access network (Open RAN) infrastructure in communication with a core network and a mobile edge computing (MEC) infrastructure, a request for initiation of a packet data unit (PDU) session from each of one or more autonomous vehicles. The method also includes identifying each of the one or more vehicles via a corresponding one of the PDU sessions. The method also includes obtaining, at a MEC orchestrator deployed in the Open Ran infrastructure, one or more Open RAN apps, MEC function apps, or combinations thereof from a catalog. The method also includes determining one or more policies by operating one or more of the MEC function apps on the MEC infrastructure and/or the core network, operating one or more of the Open RAN apps on the Open RAN infrastructure, or combinations thereof based on data collected from the one or more autonomous vehicles. The method also includes receiving the one or more policies, Open RAN apps, or combinations thereof to the MEC orchestrator. The method also includes instantiating, by the MEC orchestrator, at least one of the MEC function apps in the MEC infrastructure and/or the core network, at least one of the Open RAN apps in the Open RAN infrastructure, at least one of the policies in any of the MEC infrastructure, the Open RAN infrastructure, and/or the core network, or combinations thereof to manage one or more of a plurality of vehicle functions and/or wireless network functions in response to data collected from the one or more autonomous vehicles.

In some embodiments, the one or more autonomous vehicles include one or more of an autonomous car, an autonomous truck, an autonomous surface aquatic vehicle, an autonomous sub-surface aquatic vehicle, an unmanned aerial vehicle (UAV), or combinations thereof. In some embodiments, the one or more autonomous vehicles include one or more UAVs, each UAV comprising an onboard computer configured with a flight controller unit, an MEC host, and a wireless communication module, the UAVs in wireless communication with the wireless network. In some embodiments, the method also includes processing, by the MEC orchestrator and using artificial intelligence, data from one or more of the MEC infrastructure, the core network, the Open RAN infrastructure, the base station, the one or more autonomous vehicles, or combinations thereof. In some embodiments, the method also includes establishing wireless communication with each of the one or more autonomous vehicles via the corresponding one of the PDU sessions. In some embodiments, each autonomous vehicle includes an onboard computer configured with a flight controller unit, an MEC host, and a wireless communication module.

In some embodiments, the collected autonomous vehicle data includes one or more of, vehicle identification, computer vision, vehicle metrics, vehicle trajectory, or combinations thereof. In some embodiments, the method also includes controlling, by execution of the instantiated Open RAN apps in the Open RAN infrastructure, one or more of RAN slicing, handover from the base station of the wireless network to another base station of the wireless network, vehicle traffic steering, scheduling, resource allocation, or combinations thereof. In some embodiments, the step of controlling also includes maintaining an end-to-end latency between the ground control station and each of the autonomous vehicles of less than a maximum tolerable latency value. In some embodiments, the method also includes determining the maximum tolerable latency value as a function of an autonomous vehicle speed, a data signal type, or a combination thereof. In some embodiments, the Open RAN apps include one or more of an xApp, an rApp, or combinations thereof.

In some embodiments, the method also includes monitoring, by one or more of the instantiated Open RAN apps for each autonomous vehicle, a parameter indicative of a position, trajectory, and/or quality of service. In some embodiments, the method also includes predicting, by the MEC orchestrator, at least partially based on the monitored parameter, whether the handover to the another base station is required and/or an identity and location of the another base station. In some embodiments, the deployed one or more policies, Open RAN apps, or combinations thereof comprise a control package and the method also includes transferring the control package or a portion thereof to the another base station before the monitored parameter exceeds a threshold value. In some embodiments, the monitored parameter is end-to-end latency between the ground control station and a corresponding one of the autonomous vehicles. In some embodiments, the monitored parameter is end-to-end data rate between the ground control station and a corresponding one of the autonomous vehicles.

Additional features and aspects of the technology include the following:
1. A system for beyond line of sight control of one or more autonomous vehicles, the system comprising:
   a wireless network having open radio access network (Open RAN) infrastructure in communication with a core network, and a mobile edge computing (MEC) infrastructure, the wireless network including a MEC orchestrator deployed in the Open RAN infrastructure;
   the MEC infrastructure including:
      a plurality of MEC computing nodes, and
      a ground control station;
   at least one catalog in communication with the MEC orchestrator, the catalog including:
      a plurality of MEC function apps for operating the MEC infrastructure and/or the core network, and
      a plurality of Open RAN apps for operating the Open RAN infrastructure;
   wherein the MEC orchestrator is configured to:
   process, using artificial intelligence, data from one or more of the MEC infrastructure, the core network, the open RAN infrastructure, or combinations thereof, and
   instantiate at least one of the MEC function apps in the MEC infrastructure and/or the core network, instantiate at least one of the Open RAN apps in the Open RAN infrastructure, or combinations thereof to manage one or more of a plurality of vehicle functions and/or wireless network functions in response to data collected from the one or more autonomous vehicles.
2. The system of feature 1, wherein the one or more autonomous vehicles include one or more of an autonomous car, an autonomous truck, an autonomous surface aquatic vehicle, an autonomous sub-surface aquatic vehicle, an unmanned aerial vehicle (UAV), or combinations thereof.
3. The system of feature 2, wherein the one or more autonomous vehicles include one or more UAVs, each UAV comprising an onboard computer configured with a flight controller unit, an MEC host, and a wireless communication module, the UAVs in wireless communication with the wireless network.
4. The system of any of features 1-3, wherein the collected autonomous vehicle data includes one or more of, vehicle identification, computer vision, vehicle metrics, vehicle trajectory, or combinations thereof.
5. The system of any of features 1-4, wherein the Open RAN infrastructure is configured to execute the Open RAN apps responsive to detection of one or more vehicles operating within the wireless network in range of the Open RAN infrastructure.
6. The system of feature 5, wherein the Open RAN apps, upon execution by the Open RAN infrastructure, are configured to control one or more of RAN slicing, handover from one base station of the wireless network to another base station, vehicle traffic steering, scheduling, resource allocation, or combinations thereof.
7. The system of feature 6, wherein the Open RAN apps are configured to maintain an end-to-end latency between the ground control station and each of the autonomous vehicles of less than a maximum tolerable latency value.
8. The system of feature 7, wherein the maximum tolerable latency value is determined as a function of an autonomous vehicle speed, a data signal type, or a combination thereof.
9. The system of any of features 5-8, wherein the Open RAN apps include one or more of an xApp, an rApp, or combinations thereof.
10. The system of feature 9, wherein detection of the one or more autonomous vehicles is determined upon initiation by each autonomous vehicle of a packet data unit (PDU) session with a base station of the Open RAN infrastructure.
11. A method for beyond line of sight control of one or more autonomous vehicles, the method comprising:
   receiving, at a base station of a wireless network having open radio access network (Open RAN) infrastructure in communication with a core network and a mobile edge computing (MEC) infrastructure, a request for initiation of a packet data unit (PDU) session from each of one or more autonomous vehicles;
   identifying each of the one or more vehicles via a corresponding one of the PDU sessions;
   obtaining, at a MEC orchestrator deployed in the Open Ran infrastructure, one or more Open RAN apps, MEC function apps, or combinations thereof from a catalog;
   determining one or more policies by operating one or more of the MEC function apps on the MEC infrastructure and/or the core network, operating one or more of the Open RAN apps on the Open RAN infrastructure, or combinations thereof based on data collected from the one or more autonomous vehicles;
   receiving the one or more policies, Open RAN apps, or combinations thereof to the MEC orchestrator; and
   instantiating, by the MEC orchestrator, at least one of the MEC function apps in the MEC infrastructure and/or the core network, at least one of the Open RAN apps in the Open RAN infrastructure, at least one of the policies in any of the MEC infrastructure, the Open RAN infrastructure, and/or the core network, or combinations thereof to manage one or more of a plurality of vehicle functions and/or wireless network functions in response to data collected from the one or more autonomous vehicles.
12. The method of feature 11, wherein the one or more autonomous vehicles include one or more of an autonomous car, an autonomous truck, an autonomous surface aquatic vehicle, an autonomous sub-surface aquatic vehicle, an unmanned aerial vehicle (UAV), or combinations thereof.
13. The method of feature 12, wherein the one or more autonomous vehicles include one or more UAVs, each UAV comprising an onboard computer configured with a flight controller unit, an MEC host, and a wireless communication module, the UAVs in wireless communication with the wireless network.
14. The method of any of features 11-13, further comprising processing, by the MEC orchestrator and using artificial intelligence, data from one or more of the MEC infrastructure, the core network, the Open RAN infrastructure, the base station, the one or more autonomous vehicles, or combinations thereof;
15. The method of any of features 11-14, further comprising establishing wireless communication with each of the one or more autonomous vehicles via the corresponding one of the PDU sessions.
16. The method of any of features 11-15, wherein each autonomous vehicle includes an onboard computer configured with a flight controller unit, an MEC host, and a wireless communication module.
17. The method of any of features 11-16, wherein the collected autonomous vehicle data includes one or more of, vehicle identification, computer vision, vehicle metrics, vehicle trajectory, or combinations thereof.
18. The method of any of features 11-17, further comprising controlling, by execution of the instantiated Open RAN apps in the Open RAN infrastructure, one or more of RAN slicing, handover from the base station of the wireless network to another base station of the wireless network, vehicle traffic steering, scheduling, resource allocation, or combinations thereof.
19. The method of feature 18, wherein the step of controlling further comprises maintaining an end-to-end latency between the ground control station and each of the autonomous vehicles of less than a maximum tolerable latency value.
20. The system of feature 19, further comprising determining the maximum tolerable latency value as a function of an autonomous vehicle speed, a data signal type, or a combination thereof.
21. The method of any of features 11-20, wherein the Open RAN apps include one or more of an xApp, an rApp, or combinations thereof.
22. The method of feature 21, wherein the method further comprises:
   monitoring, by one or more of the instantiated Open RAN apps for each autonomous vehicle, a parameter indicative of a position, trajectory, and/or quality of service; and
   predicting, by the MEC orchestrator, at least partially based on the monitored parameter, whether the handover to the another base station is required and/or an identity and location of the another base station.
23. The method of feature 22, wherein the deployed one or more policies, Open RAN apps, or combinations thereof comprise a control package and the method further comprises: transferring the control package or a portion thereof to the another base station before the monitored parameter exceeds a threshold value.
24. The method of feature 23, wherein the monitored parameter is end-to-end latency between the ground control station and a corresponding one of the autonomous vehicles.
25. The method of any of features 19-24, wherein the monitored parameter is end-to-end data rate between the ground control station and a corresponding one of the autonomous vehicles.

### BRIEF DESCRIPTION OF THE DRAWINGS

FIG. 1 illustrates schematic of an intelligent network for beyond line of sight (BLOS) operation of Unmanned Aerial Vehicles (UAVs) in accordance with various embodiments.

FIG. 2, illustrates a functional flow schematic of a handover process of the intelligent network for BLOS operation of UAVs in accordance with various embodiments.

FIG. 3 illustrates an image of a prototype UAV for use in connection with the intelligent network for BLOS operation of UAVs in accordance with various embodiments.

FIG. 4 illustrates a phased development and testing process for developing and testing the intelligent network for BLOS operation of UAVs in accordance with various embodiments.

### DETAILED DESCRIPTION

Described herein are methods and systems providing intelligent networks for beyond line of sight (BLOS) operation of Unmanned Aerial Vehicles (UAVs) and other automated vehicles. Such networks integrate concepts from O-RAN, MEC, AI, and autonomous vehicles (e.g., UAVs) to develop a unified framework (also referred to herein as O-BLUE) for implementation on a wireless network (e.g., a 5G network) to provide an intelligent network for BLOS operation of automated vehicles such as UAVs. In some embodiments, the unified framework enables BLOS UAV applications combining Open RAN technologies with AI and edge computing to ensure the ubiquitous and high-performance connectivity required by BLOS applications. The inclusion of AI modules permits the intelligent network to leverage the enormous amount of data generated by the RAN, and exposed through the O-RAN interfaces, to analyze the current network conditions, forecast future traffic profiles and demand, and implement closed-loop network control strategies to optimize the RAN performance.

Such intelligent networks advance BLOS UAV applications by combining AI, Open RAN architectures and edge computing to enable and support BLOS UAV applications over 5G or other wireless networks. In such intelligent networks using the O-BLUE framework, UAVs are connected to Ground Control Stations (GCS) via the 5G infrastructure. Moreover, by building on top of the Open RAN architecture (e.g., the architecture proposed by the O-RAN Alliance), O-BLUE leverages Radio Access Network (RAN) Intelligent Controllers (RICs) and AI to adapt wireless network (e.g., 5G network) functionalities and parameters according to UAV mobility patterns and changing traffic and channel conditions, so as to ensure stable and low-latency communications between UAVs and GCS.

The technology supports automated vehicle, including UAV-based, applications for 5G systems and beyond. Specifically, the technology offers a reliable architecture and algorithms capable of supporting beyond line of sight (BLOS) use cases (e.g., package delivery, infrastructure monitoring, sensing, warehouse management, to name a few) where the lack of line of sight with the vehicle requires constant and reliable connectivity. The most demanding case is BLOS UAVs, which generally require a maximum latency of 100 ms, particularly for command and control signaling.

This is achieved via an automated orchestration framework that combines edge computing, AI and Open RAN principles (i.e., following the O-RAN Alliance specifications) to support UAV applications, with specific focus on BLOS deployments where the connectivity between automated vehicles and the 5G network must be guaranteed at all times and with low latency (e.g., below 100 ms) to ensure that remote pilots can prevent accidents in a timely manner despite being out of sight.

The framework embeds, within the intelligent network, an intelligent orchestration system and a set of AI algorithms that continuously monitor network performance and Key Performance Indicators (KPIs) to ensure low-latency and high-quality communications link between the UAV and the base of operations, automatically orchestrate edge computing services (e.g., video transcoding, computer vision for obstacle and human detection, automated inventory, asset tracking) and AI solutions (e.g., xApps and rApps to control Radio Access Network (RAN) slicing policies, scheduling profiles, power control, handover management, load balancing, dynamic flight plan adaptation) to follow the automated vehicle (e.g., a flying UAV) and guarantee the safety and efficiency of vehicle operations.

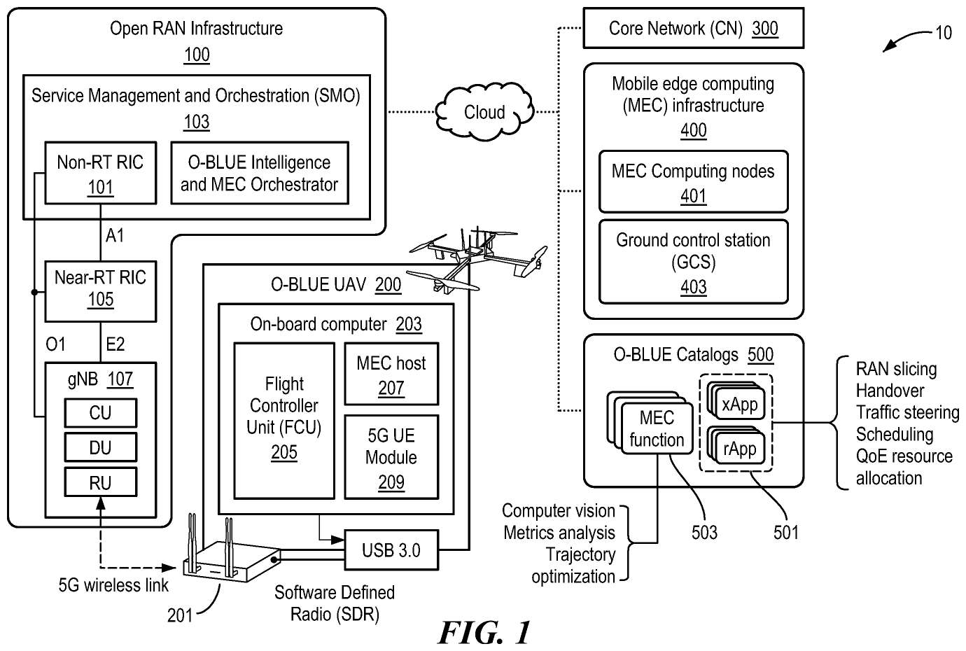

As shown in FIG. 1, the system architecture 10 includes a wireless network having an Open RAN infrastructure 100 having a non-real time (Non-RT) RAN Intelligent Controller (RIC) 101 and a Service Management & Orchestrator (SMO) 103 which host an intelligent MEC orchestrator implemented as an Open RAN app 501 (e.g., rApp). The Open RAN infrastructure 100 can also include one or more near-real-time (Near-RT) RICs 105, each hosting one or more Open RAN apps 501 (e.g., xApps). Open RAN apps 501 can host the AI and/or other solutions instantiated by the SMO 103 and can be deployed and/or instantiated anywhere in the Open RAN infrastructure 100, including at the Non-RT RIC 101 (e.g., as rApps), at the Near-RT RIC 105 (e.g., as xApps), or at one or more base stations 107 (gNBs as shown) (e.g., as xApps or dApps), including at one or more central units (CU), distributed units (DU), or radio units (RU) of the base stations 107, or combinations of such locations.

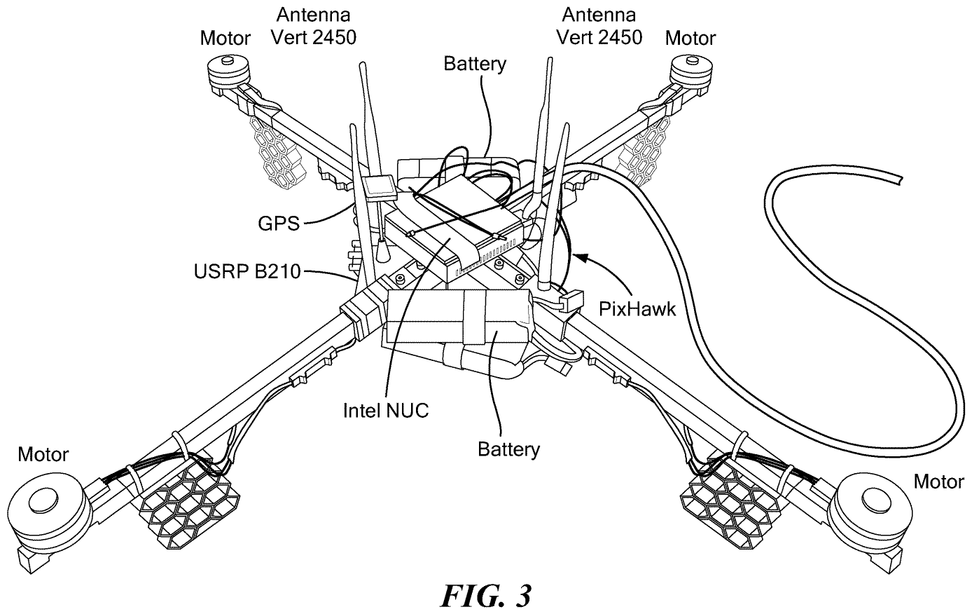

The system 10 also includes one or more automated vehicles 200 (e.g., UAVs as shown) that act as User Equipment (UE) and connect to the wireless network of the system 10 via one or more of the base stations 107. The autonomous vehicles can include any autonomous vehicle including, for example, one or more of an autonomous car, an autonomous truck, an autonomous surface aquatic vehicle, an autonomous sub-surface aquatic vehicle, an unmanned aerial vehicle (UAV), or combinations thereof. The vehicles 200 can include a software defined radio 201 for communicating with the base stations 107 and an on-board computer 203 having a control unit 205 (e.g., a flight controller unit as shown), an MEC host 207 for interacting with multi-access edge computing (MEC) infrastructure 400 of the system 10, and a UE module 209. An example of a prototype UAV for use in connection with the system 10 is illustrated in FIG. 3.

A core network 300 of the system 10 is provided in communication with the Open RAN infrastructure 100 via the SMO 103 to support data delivery to and from the vehicles 200 and multi-access edge computing (MEC) infrastructure 400 is provided for hosting computed vision and edge computing services via one or more MEC computing nodes 401. In some embodiments such computing services can include support for specific use cases (e.g., barcode and QRcode scanning for automated inventory, human and obstacle detection for emergency landing and halting, among others). The computing services can be delivered via one or more MEC function apps 503 executed by the MEC infrastructure 400. A ground control station 403 can serve as a base of operations that interfaces with autonomous vehicles 200 to obtain real-time telemetry, interact with, and control the autonomous vehicles (e.g., to update a flight plan, trigger an emergency landing, start and stop, audio/video streaming from the autonomous vehicle, among others).

In use, the MEC orchestrator 102 can obtain the Open RAN apps 501 and the MEC function apps 503 from one or more app catalogs 500 and deploy and/or instantiate them within the Open RAN infrastructure, the core network 300, the MEC infrastructure 400, or combinations thereof as appropriate.

### Concept and Architecture

The intelligent networks provided herein include the following capabilities:

Mobile intelligence and services: in order to ensure low latency, deployment and execution of intelligence and services at the edge and as close as possible to the moving vehicles is provided. Moreover, O-BLUE embeds the necessary intelligence and service orchestration tools (executed, for example, in the form of rApps) that make it possible to “follow” the vehicles and deploy both AI (e.g., in the form of xApps and rApps) and services (e.g., computer vision for obstacle detection, infrastructure inspection, task offloading) at the nearest location (e.g., the near-real-time RIC and the MEC cluster that is the closest to the DU serving the UAV).

Prioritization of BLOS Automated Vehicle Traffic: O-BLUE embeds a set of xApps that are designed to intelligently control network slicing and scheduling policies so as to give priority to the BLOS automated vehicle traffic. Specifically, O-BLUE leverages network slicing and AI to assign a dedicated slice of the network to the automated vehicle traffic and determine the optimal number of radio resources, e.g., Physical Resource Blocks (PRB), to be assigned to the slice and determine the best scheduling policy that satisfies the requirements of the UAV traffic while fostering coexistence with other users of the network.

Portability via Open RAN: By adopting Open RAN principles, O-BLUE embraces a container and microservices-based solution that offers a portable platform that can be easily instantiated on any O-RAN-compliant network as well as experimental platforms such as Colosseum, Arena, and the PAWR platforms such as AERPAW. This is made possible by the O-BLUE architecture, shown in FIG. 1, which, as described above, features the following core components:

Open RAN Infrastructure: The O-BLUE framework embraces the O-RAN paradigm and inherits the major components of its architecture. Specifically, the architecture integrates both non-RT RICs 101 and near-RT RICs 105, a RAN with disaggregated base stations 107 (e.g., gNBs) and a core network (CN). The RICs host xApps and rApps that embed the AI (described below) necessary to enable and support BLOS UAV communications via the 5G infrastructure.

MEC Infrastructure: MEC infrastructure 400 can be is distributed across system and offers the computing resources to execute the edge computing services that are required by specific applications. In some instances, the MEC infrastructure 400 can also be used to host the RICs 101, 105, as well as disaggregated gNB components that are deployed at the edge such as DUs and CUs.

App Catalogs: the app catalog 500 includes a set of apps that can be executed in connection with the system 10. The app catalog 500 can include an Open RAN catalog 501 storing the Open RAN apps 501 such as rApps, xApps and dApps relevant to the system 10. Such Open RAN apps 501 can provide, for example, latency monitoring (e.g., to ensure that latency does not exceed a maximum threshold while the UAV moves from one location to another), network slicing and scheduling control (e.g., to prioritize UAV traffic), and handover management (e.g., to determine when to trigger a handover and determine the best neighboring base station(s) to receive the handover), among others. The app catalog 500 can also include an MEC Catalog 503 storing the MEC function apps 503. The MEC function apps 503 can provide, for example, edge services relevant to the system 10, including, for example, human and obstacle detection, infrastructure monitoring, asset tracking, and automated inventory, among others. More generally, Open RAN apps 501 can be included for any service or function providable by the Open RAN infrastructure 100 and MEC function apps 503 can be included for any service or function providable by the MEC infrastructure 400.

Intelligent MEC orchestrator: The MEC orchestrator 102 is in charge of dispatching and orchestrating delivery of services throughout the system via policy determination and implementation as well as deployment and instantiation of Open RAN apps 501 and MEC function apps 503 to deliver appropriate services throughout the system 10 according to current network conditions and autonomous vehicle 200 trajectory. The role of the orchestrator 102 is central to offering the necessary tools to adaptively deploy intelligence and edge services so as to ensure that the autonomous vehicles are always connected, with low latency, to the network. MEC orchestrator 102 also takes care of automating the selection, dispatching and life-cycle management of Open RAN apps 501, MEC function apps 503, and provision of MEC services. In some embodiments, the applications and services can be deployed and/or instantiated via one or more containers, microservices, or combinations thereof in a control package so as to be portable, fast, and easy to instantiate.

Autonomous Vehicle Node(s): Each autonomous vehicle 200 acts as a 5G User Equipment (UE) and embeds small computational capabilities to execute basic tasks (e.g., obstacle detection, vehicle control, video streaming) that do not need to be offloaded to the MEC infrastructure 400.

Ground Control Station (GCS): The GCS 403 is a software component used by remote pilots and autonomous vehicle owners to monitor the autonomous vehicles and interact with the control unit 205 by sending command and control (C2) directives to update the flight trajectory, receive telemetry and/or multimedia, and execute emergency stop, among others.

### System Operation

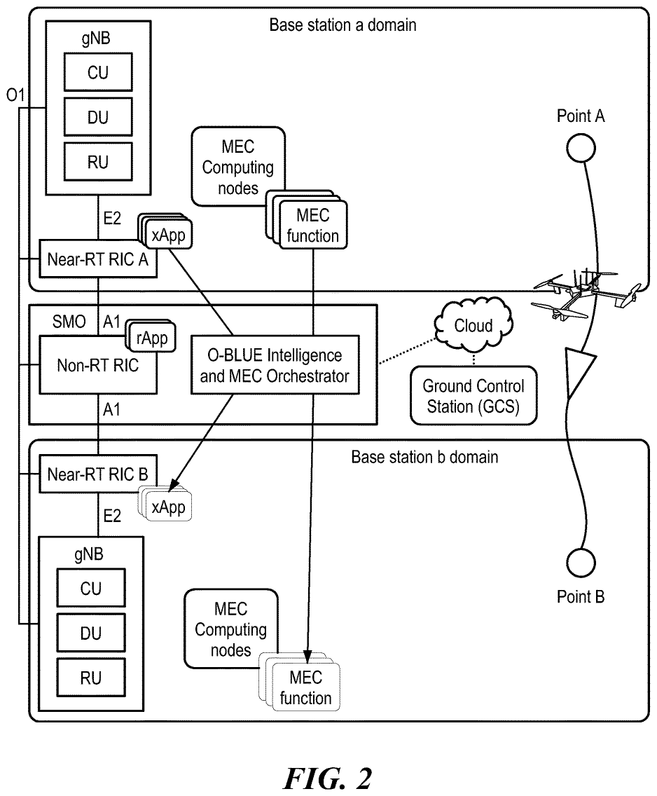

FIG. 2 illustrates a practical example of operation of the system 10 in the context of supporting BLOS UAV operations. As shown, a UAV is following a flight plan from point A to point B. Because point A is located in the domain or coverage area of base station a, the UAV is initially connected to base station a. Because the UAV is likely to share base station a with other UEs, maintaining a high throughput, low latency connection requires the provision of differentiated services by base station a to prioritize the UAV traffic (especially C2 traffic) over less time-sensitive traffic. Thus, O-BLUE instantiates a UAV slice that serves UAVs throughout the network. As shown, an xApp executing within the near-real-time RIC A is in charge of controlling base station a by assigning the UAV slice with a reserved number of PRBs as well as a scheduling profile tailored to optimally serve UAV traffic.

Another Open RAN app keeps monitoring the end-to-end latency from the GCS to the UAV to make sure that the latency remains below a threshold t. At the same time, the UAV may be performing road infrastructure monitoring tasks (e.g., detection of holes) where high-resolution video and pictures captured by the UAV are sent to the edge to be processed and analyzed in the MEC computing nodes via one or more MEC function apps. Upon approaching point B, the UAV moves away from the domain of base station a, which results in a corresponding increase in latency. Upon detecting the increase in the latency via the latency monitor xApp/rApp, the orchestrator (residing within the non-real-time RIC domain) coordinates with the handover management xApp/rApp to determine (i) if a handover is required; (ii) to which base station the UAV should attach to; and (iii) whether or not edge services and Open RAN apps (xApps as shown) should be moved closer to the UAV.

For example, in this case, the UAV approaches base station b which belongs to the domain of near-real-time RIC B. Therefore, the O-BLUE system intelligence determines that a handover should be triggered and autonomously instantiates the required xApps and edge services to the new near-real-time RIC and MEC domains so as to ensure that, upon completion of the handover procedure, both xApps and edge services are already instantiated in the new domain. Once the handover is completed, the Open RAN apps and edge services hosted in the old domain are stopped and eventually deleted.

### Implementation Development and Testing for UAV Applications

Initially, development of Open RAN apps was undertaken for data collection, design and training of AI-based network slicing and scheduling control solutions to be implemented as Open RAN apps. Those solutions needed to be general and be configured to ensure that the latency of UAV traffic remains below a given threshold under varying channel, traffic, coverage, and mobility conditions. Software such as OpenRAN Gym is used to convert those solutions into actionable Open RAN apps (xApps as developed).

In addition, development of Open RAN and MEC function apps for handover management and orchestration in connection with high-mobility UAV applications was undertaken by first determining optimal handover strategies as well as container and microservices adaptive migration solutions to ensure that the necessary Open RAN apps and MEC services can be seamlessly migrated from one area of the network to another while maintaining continuous connectivity and low latency.

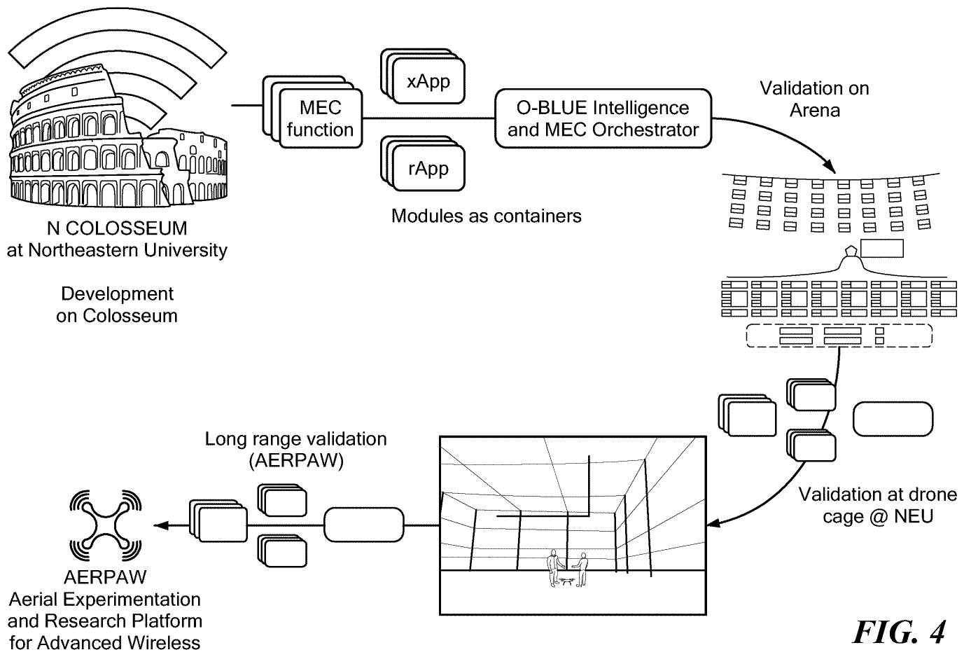

In test scenarios, such development proceeded in parallel with step-by-step testing phases as described below with reference to FIG. 4. The testing steps start with emulations, and then terminate with flying experiments with over-the-air transmissions. This allows the necessary data collection activities to support the design, development, training, and testing of O-BLUE components, and then allows transition gradually to end-to-end experiments on a short-and long-range over-the-air testbeds. These four steps are as follows:

Development: Development was performed using Colosseum, which is a massive channel emulator and traffic generator that makes it possible to design, develop and test solutions for wireless networks under a virtually infinite amount of RF and network scenarios. Its resources can be reserved through a web-based interface and are then accessed remotely to execute and monitor experiments. It is possible to use available scenarios or code new ones and emulate complex wireless systems with flying UAVs, mobile UEs and full stack 5G Open RAN networks. Colosseum provides the opportunity to perform data collection under realistic network conditions and deployments, so as to have enough data to train O-BLUE components.

Controlled Environment Validation: Initial validation was performed using Arena, which is a 64-antenna SDR indoor testbed offering both radio and compute nodes. This phase transitions from the emulated environment of Colosseum to an over-the-air testbed in a controlled environment, thus providing the opportunity to validate modules in a real-world wireless deployment;

Drone Cage Validation: Further validation was performed within a football field-sized drone cage to permit over-the-air flight experiments in an outdoor setup where UAVs can fly in safety. While the drone cage only supports LOS communications, this is used to test the automated pipelines of O-BLUE while at the same time having a direct LOS link to the UAV to maintain a high level of safety;

Long Range Validation: Long range validation was performed on AERPAW, which is a wireless experimental platform designed to advance research in the UAV domain. It includes of a series of UAVs and other wireless nodes that can be used to test UAV solutions across a variety of deployment scenarios. This testbed is used to demonstrate O-BLUE capabilities in supporting BLOS 5G communications for UAVs.

Thus, O-BLUE paves the way toward fully automated UAV networks for BLOS applications. Apart from enabling the realization of many BLOS UAV applications that have not been possible so far, it also allows the development of new services and uses. Given the possibility to deploy and execute intelligence and services close to the edge that can “follow” the UAVs, new use cases will also arise, creating the possibility for enhanced services. Applications that can benefit from O-BLUE include safe and efficient delivery of packages for under-served and rural communities with outdated road infrastructure, fully autonomous UAVs for continuous surveillance and monitoring purposes, asset tracking, and video streaming for disaster and emergency scenarios. Those use-cases will be enabled by O-BLUE's orchestrated intelligence and network automation, which will facilitate the lifecycle management of networking functionalities and services, while ensuring extreme flexibility and reconfiguration according to current channel, network, and traffic conditions, thus removing human error while maintaining the highest level of quality of service.

Further applications of this technology include the following:

### Large-scale Swarms:

O-BLUE can be extended to operate with swarms of UAVs. This AI capable of generalizing across an indefinite and possibly varying number of UAVs, as well as handover and network slicing algorithms that effectively allocate radio resources to keep the latency of each UAV below a given threshold.

### UAV-to-UAV Coordination:

Sidelink can leverage technologies to support UAV-to-UAV communications and facilitate coordination between UAVs. This allows UAVs to leverage sidelink communications to maintain connectivity to a 5G base station via multi-hop communications, so as to avoid loss of connectivity even in areas that are only partially covered.

### Additional Uses:

Uses of the present technology include Industry 4.0, operation of smart farms, smart warehouses, infrastructure monitoring, asset tracking, and package delivery.

The present technology includes the following novel features:
The first automated AI and MEC orchestration system that supports UAV applications. The system leverages AI, MEC and Open RAN principles to enable UAV applications for Industry 4.0, package delivery, infrastructure monitoring and asset tracking.
The technology leverages a fabric of O-RAN xApps and rApps to distribute network intelligence and offer dynamic redeployment of such apps to follow UAVs and ensure the best performance and ubiquitous control of their operations.
The AI is designed to be operational in diverse network deployments and support online AI training to improve its efficiency depending on the specific network and channel conditions.

The present technology offers the following advantages:
The technology is designed to enable UAV BLOS operations over 5G networks.
Dynamic adaptation of AI and MEC services are used to follow UAV mobility and adapt to rapidly changing network, channel, and traffic conditions.
The technology allows autonomous UAV applications for Industry 4.0, warehouse management, and asset tracking.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

1. A system for beyond line of sight control of one or more autonomous vehicles, the system comprising:
a wireless network having open radio access network (Open RAN) infrastructure in communication with a core network, and a mobile edge computing (MEC) infrastructure, the wireless network including a MEC orchestrator deployed in the Open RAN infrastructure;
the MEC infrastructure including:
a plurality of MEC computing nodes, and
a ground control station;
at least one catalog in communication with the MEC orchestrator, the catalog including:
a plurality of MEC function apps for operating the MEC infrastructure and/or the core network, and
a plurality of Open RAN apps for operating the Open RAN infrastructure;
wherein the MEC orchestrator is configured to:
process, using artificial intelligence, data from one or more of the MEC infrastructure, the core network, the open RAN infrastructure, or combinations thereof, and
instantiate at least one of the MEC function apps in the MEC infrastructure and/or the core network, instantiate at least one of the Open RAN apps in the Open RAN infrastructure, or combinations thereof to manage one or more of a plurality of vehicle functions and/or wireless network functions in response to data collected from the one or more autonomous vehicles.

2. The system of claim 1, wherein the one or more autonomous vehicles include one or more of an autonomous car, an autonomous truck, an autonomous surface aquatic vehicle, an autonomous sub-surface aquatic vehicle, an unmanned aerial vehicle (UAV), or combinations thereof.

3. The system of claim 2, wherein the one or more autonomous vehicles include one or more UAVs, each UAV comprising an onboard computer configured with a flight controller unit, an MEC host, and a wireless communication module, the UAVs in wireless communication with the wireless network.

4. (canceled)

5. The system of claim 1, wherein the Open RAN infrastructure is configured to execute the Open RAN apps responsive to detection of one or more vehicles operating within the wireless network in range of the Open RAN infrastructure.

6. The system of claim 5, wherein the Open RAN apps, upon execution by the Open RAN infrastructure, are configured to control one or more of RAN slicing, handover from one base station of the wireless network to another base station, vehicle traffic steering, scheduling, resource allocation, or combinations thereof.

7. The system of claim 6, wherein the Open RAN apps are configured to maintain an end-to-end latency between the ground control station and each of the autonomous vehicles of less than a maximum tolerable latency value.

8. The system of claim 7, wherein the maximum tolerable latency value is determined as a function of an autonomous vehicle speed, a data signal type, or a combination thereof.

9.-10. (canceled)

11. A method for beyond line of sight control of one or more autonomous vehicles, the method comprising:
receiving, at a base station of a wireless network having open radio access network (Open RAN) infrastructure in communication with a core network and a mobile edge computing (MEC) infrastructure, a request for initiation of a packet data unit (PDU) session from each of one or more autonomous vehicles;
identifying each of the one or more vehicles via a corresponding one of the PDU sessions;
obtaining, at a MEC orchestrator deployed in the Open Ran infrastructure, one or more Open RAN apps, MEC function apps, or combinations thereof from a catalog;
determining one or more policies by operating one or more of the MEC function apps on the MEC infrastructure and/or the core network, operating one or more of the Open RAN apps on the Open RAN infrastructure, or combinations thereof based on data collected from the one or more autonomous vehicles;
receiving the one or more policies, Open RAN apps, or combinations thereof to the MEC orchestrator; and
instantiating, by the MEC orchestrator, at least one of the MEC function apps in the MEC infrastructure and/or the core network, at least one of the Open RAN apps in the Open RAN infrastructure, at least one of the policies in any of the MEC infrastructure, the Open RAN infrastructure, and/or the core network, or combinations thereof to manage one or more of a plurality of vehicle functions and/or wireless network functions in response to data collected from the one or more autonomous vehicles.

12. The method of claim 11, wherein the one or more autonomous vehicles include one or more of an autonomous car, an autonomous truck, an autonomous surface aquatic vehicle, an autonomous sub-surface aquatic vehicle, an unmanned aerial vehicle (UAV), or combinations thereof.

13. (canceled)

14. The method of claim 11, further comprising processing, by the MEC orchestrator and using artificial intelligence, data from one or more of the MEC infrastructure, the core network, the Open RAN infrastructure, the base station, the one or more autonomous vehicles, or combinations thereof.

15. The method of claim 11, further comprising establishing wireless communication with each of the one or more autonomous vehicles via the corresponding one of the PDU sessions.

16. (canceled)

17. The method of claim 11, wherein the collected autonomous vehicle data includes one or more of, vehicle identification, computer vision, vehicle metrics, vehicle trajectory, or combinations thereof.

18. The method of claim 11, further comprising controlling, by execution of the instantiated Open RAN apps in the Open RAN infrastructure, one or more of RAN slicing, handover from the base station of the wireless network to another base station of the wireless network, vehicle traffic steering, scheduling, resource allocation, or combinations thereof.

19. The method of claim 18, wherein the step of controlling further comprises maintaining an end-to-end latency between the ground control station and each of the autonomous vehicles of less than a maximum tolerable latency value.

20. The method of claim 19, further comprising determining the maximum tolerable latency value as a function of an autonomous vehicle speed, a data signal type, or a combination thereof.

21. The method of claim 11, wherein the Open RAN apps include one or more of an xApp, an rApp, or combinations thereof.

22. The method of claim 21, wherein the method further comprises:
monitoring, by one or more of the instantiated Open RAN apps for each autonomous vehicle, a parameter indicative of a position, trajectory, and/or quality of service; and
predicting, by the MEC orchestrator, at least partially based on the monitored parameter, whether the handover to the another base station is required and/or an identity and location of the another base station.

23. The method of claim 22, wherein the deployed one or more policies, Open RAN apps, or combinations thereof comprise a control package and the method further comprises:
transferring the control package or a portion thereof to the another base station before the monitored parameter exceeds a threshold value.

24. The method of claim 23, wherein the monitored parameter is end-to-end latency between the ground control station and a corresponding one of the autonomous vehicles.

25. The method of claim 19, wherein the monitored parameter is end-to-end data rate between the ground control station and a corresponding one of the autonomous vehicles.
